(19) United States
(12) Patent Application Publication
(10) Pub. No.: US 2011/0014929 A1
(43) Pub. Date: Jan. 20, 2011

(54) LOCATION SPECIFIC STREAMING OF CONTENT

(75) Inventors: Darius Mohammad Moshfeghi, Stanford, CA (US); Andrew Akbar Moshfeghi, Jupiter, FL (US); John William Kitchens, Lexington, KY (US); Thomas William Stone, Lexington, KY (US)

Correspondence Address: TUROCY & WATSON, LLP, 127 Public Square, 57th Floor, Key Tower, CLEVELAND, OH, 44114, US

(73) Assignee: Convene, LLC, Stanford, CA (US)

(21) Appl. No.: 12/505,574

(22) Filed: Jul. 20, 2009

(51) Int. Cl. H04W 24/00

(52) U.S. Cl. 455/456.3

(57) ABSTRACT

The claimed subject matter provides systems and/or methods that stream pertinent and/or selected content to a mobile device based at least in part on the location of the mobile device. The system can include components that detect the presence of a mobile device within a coverage area dynamically demarcated by an access point, determine the mobile device location in relation to the access point, and thereafter supplies event information to the mobile device based on the mobile device location in relation to the access point.

### BACKGROUND

Microprocessor-based devices have evolved into reliable and pervasive tools that facilitate common everyday tasks (e.g., microwave cooking, automobile ignition systems, entertainment centers, . . . ), complex mathematical computations (e.g., forecasting, trending, and the like), sophisticated applications (e.g., computational fluid dynamics modeling, business workflow, word processing, financial logging, electronic mail, etc.), and the like. Such devices typically include one or more processors and various types of memory as well as other components that enable efficient and robust multitasking. Incremental advances in electronics, networking, and software technologies have resulted in reduced device production costs that have correlated to decreased consumer purchasing costs, which in turn have rendered computers (e.g., hand-held, desktop, laptop, . . . ) essentially ubiquitous throughout many portions of the world.

Mobile devices are becoming a pervasive and all encompassing device for communication, entertainment, commerce, and personal finance. Moreover, there is an ongoing push towards technological convergence where previously separate technologies, such as voice (and telephony features), data and productivity applications, and video can now share resources and interact with one another, synergistically creating new efficiencies on a single device. Mobile devices today can thus be utilized to accomplish many tasks that had previously been performed on larger form factor devices or had been performed using many disparate devices.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with various aspects set forth herein provides machine-implemented systems and methods that stream pertinent and/or selected content to mobile devices based at least in part on the location of the mobile devices in relation to the system. In particular, the claimed subject matter provides systems and methods that identify mobile devices within a broadcast coverage range circumscribed by an access point, ascertains the positions of the mobile devices in relation to the access point, and thereafter supplies content from the access point to the mobile devices based at least in part on each mobile device's position in relation to the access point.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that streams pertinent and/or selected content to a mobile device based at least in part on the location of the mobile device in relation to the system.

FIG. 2 depicts further illustration of a machine-implemented system that streams pertinent and/or selected content to a mobile device in accordance with an aspect of the claimed subject matter.

FIG. 3 provides depiction of an illustrative access point that can effectuate distribution of pertinent and/or selected content to mobile devices in accordance with an aspect of the claimed subject matter.

FIG. 4 provides further illustration of an access point that can effectuated distribution of pertinent and/or selected content to mobile devices in accordance with various aspects of the claimed subject matter.

FIG. 5 provides depiction of an illustrative mobile device that can receive pertinent and/or selected content from one or more access points dispersed throughout a conference center in accordance with an aspect of the claimed subject matter.

FIG. 6 illustrates a flow diagram of a machine implemented methodology that streams pertinent and/or selected content to a mobile device in accordance with an aspect of the claimed subject matter.

FIG. 7 depicts a further flow diagram of a machine implemented methodology that streams pertinent and/or selected content to a mobile device in accordance with an aspect of the claimed subject matter.

FIG. 8 illustrates yet a further flow diagram of a machine implemented methodology that streams pertinent and/or selected content to a mobile device in accordance with an aspect of the claimed subject matter.

FIG. 9 illustrates a further utilization of the claimed subject matter in accordance with various aspects of the claimed subject matter.

FIG. 10 illustrates yet a further utilization of the claimed subject matter in accordance with an aspect of the claimed subject matter.

FIG. 11 illustrates a block diagram of a computer operable to execute the disclosed system in accordance with an aspect of the claimed subject matter.

FIG. 12 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

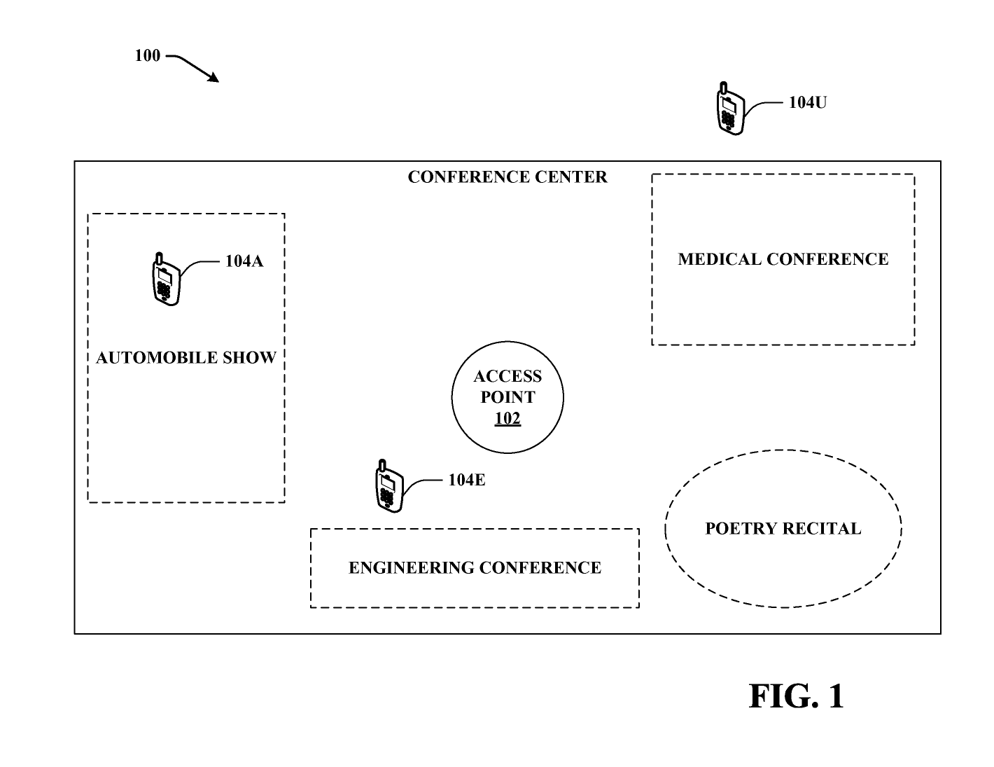

FIG. 1 illustrates a system 100 that streams pertinent and/or selected content to a mobile device based at least in part on the location of the mobile device in relation to the system. As depicted, system 100 can include access point 102 that can be situated within a multifunction conference center. Access point 102 can be communicatively coupled to one or more mobile devices (e.g., mobile devices 104A, 104E, and 104U). Since the basic premise of the claimed subject matter is that users of mobile devices, such as illustrative mobile devices 104A, 104E, and 104U, as they come within the ambit of access point 102 will receive selected and/or specific content (e.g., audio, visual, text messages, electronic mail, etc.) pertinent to their needs and wants and in relation to the conferences/meetings/conventions running within the conference center. For instance and as illustrated, the conference center can currently be holding an automobile show, a medical conference, an engineering conference, and a poetry recital, and as such access point 102 can provide details regarding these events with varying degrees of granularity to the various mobile devices within its vicinity. For example, mobile device 104U can be located outside the conference center venue, and as such access point 102, in recognition that mobile device 104U is at the periphery of its range, can disseminate or stream to mobile device 104U a generic high level outline regarding the conference center and the various events that are currently taking place therein. Generic information regarding the conference venue can include contact information for the venue, history about the venue, and other pertinent details regarding the conference center. Additionally, access point 102 can also distribute generalized precis regarding the various events that the conference center is currently hosting. For instance, access point 102 can broadcast information that the poetry recital is being hosted by Local University, the poetry being recited includes Samuel Taylor Coleridge's poems “The Rime of the Ancient Mariner” and “Kula Khan”, and that at the end of the recital a discussion will take place comparing and contrasting the various themes set forth in these two poems. Further, access point 102 can also provide a similar high level overview related to each of the other events currently being hosted within the conference center.

Furthermore, access point 102, when the user together with his/her associated mobile device enters the conference center and moves within the proximity of a particular event, can provide further more detailed information to the user regarding the event to which the mobile device is proximate. For instance and as depicted, mobile device 104E can be situated within the vicinity of an engineering conference that is currently on-going. Access point 102 can ascertain, through attributes affiliated with mobile device 104E and/or user credential information persisted on, associated with, or retrieved from a disparate independent source (e.g., remote credential agency) whether or not the user has been registered to partake in the engineering conference. Where access point 102 establishes that the user and/or his/her associated mobile device 104E is not registered for the engineering conference, access point 102 can stream or provide further more specific but general information regarding the engineering conference, such as information about the presenters that are scheduled to present papers at the event, the various topics and special interest groups that are participating at the event, a time table and/or schedule of fees, . . . . Additionally and/or alternatively, access point 102 can supply registration materials for the engineering conference to mobile device 104E so that the user, if he/she so wishes, can immediately sign up for the conference. Moreover, access point 102 in conjunction with various and sundry user specific details (e.g., credit card information, digital certificates, etc.) associated with mobile device 104E can provide the functionalities and facilities necessary to effectuate payment (if this is a requirement for event attendance) for attending at the event. Where access point 102 on the other hand determines that the user and/or his/her associated mobile device 104E has pre-registered for the conference, access point 102 can stream or direct to mobile device 104E more specific and detailed information regarding the engineering conference. For example, access point 102 can stream video or audio clips of the various presenters at previous engineering conferences, outlines of papers or addendums to papers that are to be, or have been presented at the current conference, room assignments in which the various breakout session are to be held, maps related to the conference center (e.g., fire exits, restrooms, etc.), layouts of the conference, updated calendaring information regarding the event, lists of attendees, and the like.

Moreover, access point 102 can effectuate and/or facilitate tracking of mobile devices throughout the conference facility and can provide various other useful, but specific, information to respective mobile devices as they traverse through the facility. For example, if mobile device 104E (currently located proximate to the engineering conference) were to move within the vicinage of the medical conference, access point 102 can direct and stream selected information regarding the medical conference. In particular, as mobile device 104E moves away from the zone of coverage that access point 102 provides for the engineering conference, the specificity of information related to the engineering conference streamed to mobile device 104E can undergo a gradual and successive attenuation (e.g., as mobile device 104E moves away from the proximity of the engineering conference less specific information related to the engineering conference can be streamed by access point 102). Conversely, as mobile device 104E moves closer to the venue of the medical conference, the specificity of information conveyed to mobile device 104E regarding the medical conference can steadily increase. As will be appreciated, without limitation or loss of generality, by those moderately conversant in this field of endeavor, as mobile device 104E moves past or comes within the coverage areas of other conference events as defined by access point 102, information in various degrees of specificity (e.g., based at least in part on the relative proximity of mobile device 104E to the conference event) related to other conference events can be streamed or directed to mobile device 104E by access point 102. Thus for example, if mobile device 104E, on its way to the medical conference area, were to pass within the coverage zone determined by access point 102 for the automobile show, pertinent information with varying degrees of specificity related to the automobile show can be streamed to mobile device 104E. Moreover, it should further be appreciated that if mobile device 104E passes under, or in close proximity to, access point 102 (which can be centrally located within the conference center) a compendia of information related to all the various ongoing events in the conference center can be streamed to mobile device 104E.

In addition, access point 102 can keep track of mobile devices within the event for which they, or more particularly their respective user, are registered. This scenario is illustrated with respect to mobile device 104A that has been situated within the ambit of the automobile show coverage area circumscribed by access point 102. While mobile device 104A is within the automobile show coverage area access point 102 can provide interactivity and attendance taking facilities wherein registered participants can communicate with one another via their respective mobile devices. For instance, user of mobile device 104A can text message another participant at the automobile show. Additionally and/or alternatively, user of mobile device 104A through the functionalities of access point 102 can track and/or locate another participant at the automobile show, such a facility can be useful when the user of mobile device 104A has pre-arranged to meet with one or more acquaintances or where the user of mobile device 104A wishes to meet with persons with whom he/she has never met before or is unfamiliar with.

As stated above, access point 102 and mobile devices 104A, 104E, and/or 104U can be in continuous and/or operative or sporadic and/or intermittent communication with one another for the purpose of data interchange. As such, access point 102 and mobile devices 104A, 104E, and/or 104U can effectuate such communication through a network topology and/or cloud. Such a network topology and/or cloud can include any viable communication and/or broadcast technology, for example, wired and/or wireless modalities and/or technologies can be utilized. Moreover, network topology and/or cloud can include utilization of Personal Area Networks (PANs), Local Area Networks (LANs), Campus Area Networks (CAMs), Metropolitan Area Networks (MANs), extranets, intranets, the Internet, Wide Area Networks (WANs)—both centralized and/or distributed—and/or any combination, permutation, and/or aggregation thereof.

Access point 102 and mobile devices 104A, 104E, and/or 104U can be implemented entirely in hardware and/or a combination of hardware and/or software in execution. Further, access point 102 and mobile devices 104A, 104E, and/or 104U can be incorporated within and/or associated with other compatible components. Additionally, access point 102 and mobile devices 104A, 104E, and/or 104U can be, but are not limited to, any type of machine, engine, instrument of conversion, or mode of production that includes a processor and/or is capable of effective communication with a network topology and/or cloud. Illustrative instruments of conversion, machines, modes of production, engines, mechanisms, devices, and/or machinery that can comprise access point 102 and mobile devices 104A, 104E, and/or 104U can include desktop computers, cells phones, smart phones, laptop computers, notebook computers, Tablet PCs, portable or mobile consumer and/or industrial devices and/or appliances, hand-held devices, personal digital assistants, multimedia Internet mobile phones, multimedia players, and the like.

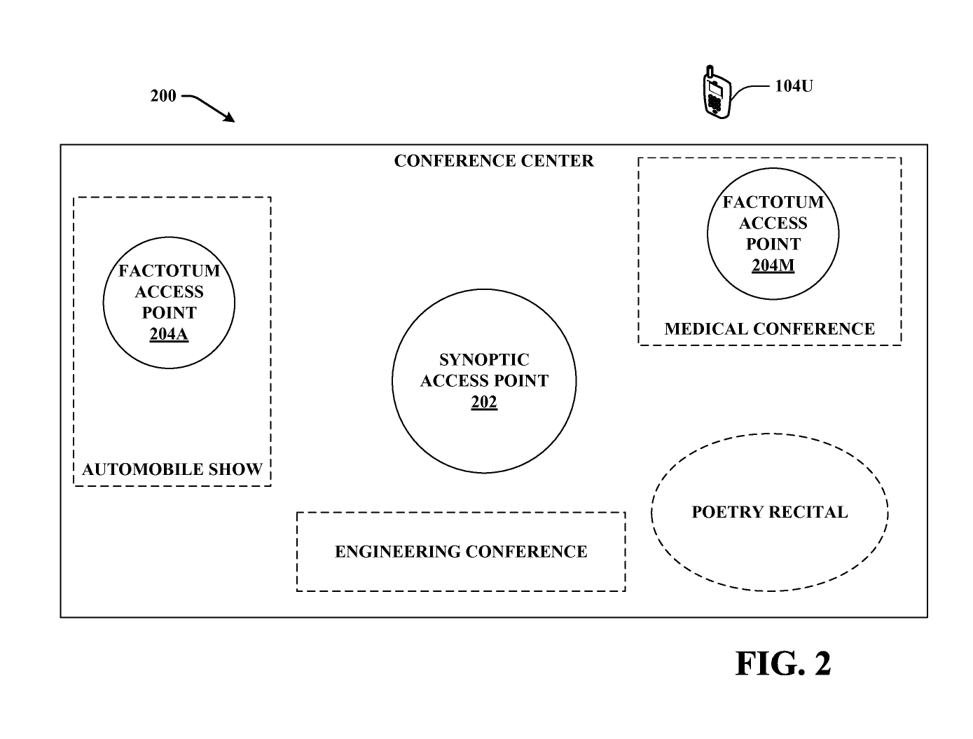

FIG. 2 provides further depiction 200 of a system that streams pertinent and/or selected content to a mobile device based at least in part on the location of the mobile device in relation to the system. Illustrated in FIG. 2 are synoptic access point 202 and factotum access points 204A and 204M that can have a similar functionality as that described above in connection with access point 102, accordingly, for the sake of conciseness of exposition and to avoid needless prolixity, discussion of such aspects has been omitted. Nonetheless, synoptic access point 202 can, for example, be centrally disposed within the conference center and can act as a focus point for the dissemination of generalized synoptic information gathered from factotum access points 204A and 204M. Accordingly, when a mobile device (e.g., mobile devices 104A, 104E, and/or 104U) is within the ambit of the conference center but is nevertheless beyond the coverage area of individual factotum access points (e.g., factotum access points 204A and 204M) generalized overview information regarding the conference center and the on-going events can be streamed to the mobile device. For example and with respect to FIG. 2, mobile device 104U can be situated outside the conference center setting, as such and as stated above, will be provided generic high level outlines regarding the conference center and the various events that are currently taking place therein. As will be appreciated, outline information regarding the conference center can be persisted locally on synoptic access point 202 or can dynamically be acquired by synoptic access point 202 from other sources, such as distributed databases located within the confines of the conference center or situated at remote data centers. With regard to overviews of the various on-going events at the conference center, this information can have been pre-provisioned on synoptic access point 202 at some earlier time or can be supplied in real-time to synoptic access point 202 by factotum access point 204A and 204M, for example.

It should be noted without limitation or loss of generality, and solely for the purposes of illustration, that when a mobile device is outside the confines of the conference center, communication is typically between synoptic access point 202 and the mobile device situated outside the conference center; factotum access points 204A and 204M generally do not partake in interchange between mobile devices located outside the conference center venue, but rather in this situation communicate information regarding their respective events to synoptic access point 202 which can in turn dispatch a synopsis to the mobile device (e.g., mobile device 104U) located outside the venue. Nevertheless, it should be realized that factotum access points 204A and 204M can partake in individual communication with mobile devices when such devices are within the broadcast coverage of the factotum access points 204A and 204M within the conference center, and further can, if required, facilitate communication with mobile devices when these mobile devices are situated outside the conference center. For instance, factotum access points 204A and/or 204M can be in continuous and/or intermittent communication with mobile devices located outside the conference center once these mobile devices have been registered for the events for which the factotum access points 204A and/or 204M are responsible. Additionally, factotum access points 204A and/or 204M, either individually and/or in concert, can take over the responsibilities of synoptic access point 202 should the need ever arise.

In view of the foregoing therefore, it will be recognized that typically synoptic access point 202 will be in constant and/or sporadic data interchange with factotum access points 204A and/or 204M, wherein factotum access points 204A and/or 204M can push various generalized event information regarding the various events for which each factotum access point is responsible. For example, factotum access point 204A can be responsible for disseminating event information specifically for the automobile show and factotum access point 204M can be responsible for streaming event information for the medical conference. Accordingly, factotum access point 204A and factotum access point 204M can respectively send to synoptic access point 202, continuously and/or on demand, information about the automobile show or the medical conference, in summarized form, so that synoptic access point 202 can broadcast this information as necessary. Additionally and/or alternatively, each of factotum access point 204A and factotum access point 204M can send the full gamut of information relating to the automobile show or medical, which synoptic access point 202 can dynamically summarize prior to streaming the summary together with any other summaries from other factotum devices located within the conference center facility to the appropriate mobile devices.

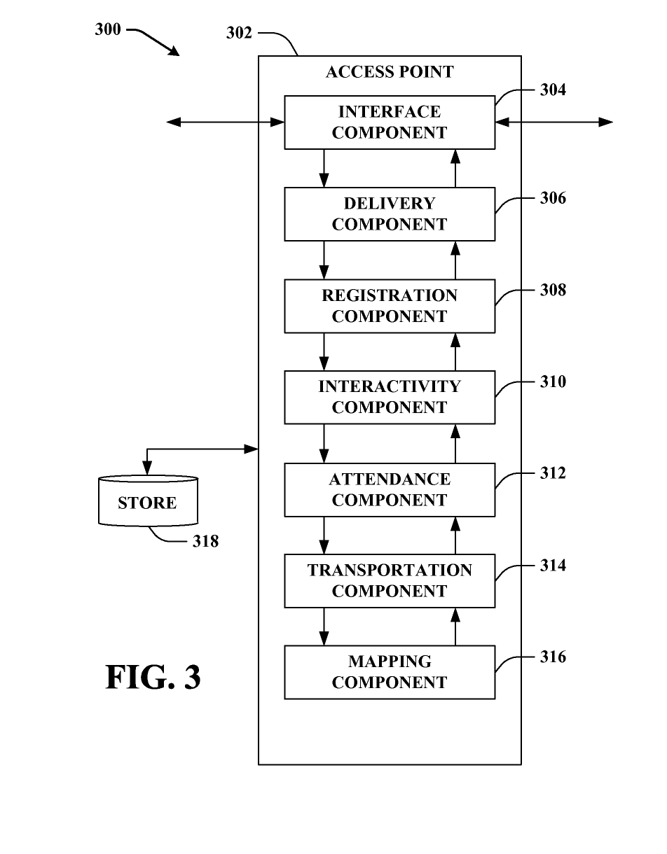

FIG. 3 provides depiction 300 of an illustrative access point 302 that can effectuate distribution of pertinent and/or selected content to mobile devices based at least in part on the location of the mobile devices in relation to access point 302. Access point 302 can provide the facilities and functionalities elucidated above with respect to access point 102, synoptic access point 202, and factotum access points 204A and 204M. Accordingly, for the sake of conciseness and avoid needless repetition, such features have been omitted from the on-going exposition.

Access point 302 as illustrated can nevertheless include any suitable and/or necessary interface component 304 (hereinafter referred to as “interface 304”) that can provide various adapters, connectors, channels, communication pathways and/or modalities, etc. to integrate access point 302 into virtually any operating and/or database system(s) and/or with one another. Additionally, interface 304 can provide various adapters, connectors, channels, communication pathways and/or methodologies, etc. to effectuate and facilitate interaction with and between access point 302, and/or any other component, module, data, and the like.

Further, access point 302 can include delivery component 306 that can provide the ability to deliver conference/convention/meeting agenda applications to mobile devices. Delivery component 306 can provide not only the mobile device agenda applications necessary to facilitate the claimed subject matter, but also the application programming interfaces and/or database interfaces that can be necessary to actuate the full functionality of the claimed matter on various mobile devices. For instance, agenda applications dispatched to mobile devices can be interactive and can be modified by users of the mobile devices and/or by conference/convention/meeting planners (e.g., via utilization of the functionalities and/or functionalities of access point 302). Modification of agenda applications can include adding various portions (e.g., talks, lectures, etc.) of the conference/convention/meeting to suit the user's specific schedule, or the ability to push schedule changes or recommendations of conference/convention/meeting activities that can be of interest to the user based at least in part on registration information provided by the user through the agenda application dispatched to the mobile device, or via any other online conduit (e.g., the Internet, . . . ). As will be appreciated, modification of agenda applications can be performed in real-time and can include updating or apprising the user on events or activities at the conference/convention/meeting that can be running behind schedule.

In accordance with one aspect, delivery component 306 can forward individualized or personalized agendas to the mobile device for use by the user. Additionally and/or alternatively, conference/convention/meeting agendas, in whole or in part, can be forwarded to calendaring or To Do applications associated with the mobile device. Further, individualized or personalized agendas can be forwarded to, or posted for, other registered users of the conference/convention/meeting to procure. As will be appreciated by those moderately conversant in this field of endeavor, for security purposes, this facility can require that before such individualized or personalized agendas are forwarded or posted that the individuals for whom the personalized agendas are created authorize such actions. For example, inclusion or exclusion lists can be utilized to selectively allow or prevent access to individualized or personalized agendas.

In accordance with a further aspect, delivery component 306 can cause the dissemination of submitted abstracts (of papers presented at the conference) or book content wherein such abstracts or book content can be made available on demand via the display facilities of the mobile device, or to be downloaded and/or persisted locally on the mobile device a priori together with all the other selected presentations included in an individual's agenda so that they can be viewed when the mobile device is out of range of access point 302.

Moreover, access point 302 can include registration component 308 that can provide the ability for the user of a mobile device to register to a conference or meeting for which they may not have registered for in advance or to register for additional events at the conference or meeting for which the user was either unaware or were added subsequent to the user registration. Notification of these additional events can be pushed to the user's mobile device by delivery component 306 based at least in part on a user's previously elicited interests or previously attended events. Additionally, inference of additional events that can be of interest to the user and for which the user needs to be made aware can be effectuated through use of data mining, machine learning, or artificial intelligence techniques.

Registration component 308 can also provide users the ability to register for upcoming conferences/meetings/conventions through their mobile devices. Registration component 308 can provide recommendations for upcoming events using inferences provided through use of data mining, machine learning or artificial intelligence techniques wherein a user's previously elicited interests and/or previously attended events can be utilized to generate the recommendations. In an ancillary aspect, registration component 308 can also make travel and/or accommodation recommendations for future events that the user registers for via the mobile device. In accordance with this ancillary aspect, the user can be provided the ability to purchase or secure these travel and/or accommodation recommendations through their mobile device (e.g., via hyperlinks supplied by access point 302).

Moreover, registration component 308 can dispatch reminders for meeting deadlines (e.g., for presenters to provide their abstracts, for users to make travel and/or housing arrangements, etc.) to mobile devices and can also send information on future meetings that the user has registered for (or communicated an interest in) to the user or to groups of colleagues from a prior event, meeting, conference, or convention.

In accordance with a further aspect, registration component 308 can provide access to various meeting information including, but not limited to: handouts, notes, diagrams, slides, web pages, audio and/or visual presentations, resumes of presenters and/or conference attendees, photographs, disclosures, and/or other pertinent meeting materials. Additionally, registration component 308 can provide to users' mobile devices the ability to take notes on various lectures that can be scheduled for a particular event for which they are registered, and furthermore can also provide the ability for users to print, share, distribute (e.g., via email, text message, . . . ), or convert into another digital format these notes, or selected portions thereof, for viewing on a different platform.

Access point 302 can also include interactivity component 310 that can provide users the ability to use their mobile device to digitally sign-in (e.g., via cellular service, WiFi, Bluetooth, GPS, WiMax or by keying in specific codes prior to, during, or on completion of a particular event) to any conference, convention, or meeting activity. This facility can allow users to register for meeting credits (e.g., continuing legal education (CLE), continuing medical education (CME)) and to provide verification of activity attendance for their employers or accreditation bodies, or for any other reason personal or business related. Additionally, such attendance information can also be provided to other attendees in real-time if so authorized by the user.

Interactivity component 310 can also provide facilities for users to interact with conference, meeting, or convention speakers, presenters, or organizers via queries which can be pushed to users' mobile devices. These interactions can include, but are not limited to: yes/no or multiple choice questions, questions involving a text response, polls, surveys, votes, event evaluations, and the like. Such interactions can also include real-time evaluations of the various conference presenters, speakers, debaters, or other event related activities.

Additionally, interactivity component 310 can also provide users the ability to convey queries to conference or meeting presenters or organizers, as well as other conference attendees via text message, instant messaging, message boards, blogs, or twitter-like functionality, for example. Further, interactivity component 310 can provide conference or convention organizers the ability to send messages to any conference attendee or selected groups of attendees so as to provide these recipients with relevant updates regarding conference or meeting activities.

Furthermore, through interactivity component 310, registered mobile device users can send their personal or business information in a digital format to other conference or convention attendees or groups of attendees, vendors, or to the conference or convention organizers. Such personal or business information provided in digital format can be stored into an address book associated with the mobile device, and further can be utilized to make recommendations regarding fellow attendees that can have similar interests or backgrounds (e.g., training, associations with other colleagues, educational achievements, etc.) for social and/or business networking purposes.

It should be appreciated that interactivity component 310 can provide anonymizing functionalities such that attendees on registering for a conference or meeting can provide the networking characteristics of their mobile device (e.g., media access control address, phone number, etc.) but during the conference or meeting only the name of the attendee is listed or displayed to other attendees of the meeting or conference. Thus, where conference attendees wish to communicate with one another via text message, for example, this can be accomplished by clicking on their names, and as such disclosure of attendees' real mobile numbers can be masked.

Access point 302 can further include attendance component 312 which can provide digital representations (e.g., digital images) of attendees of various events to speakers, fellow conference or meeting attendees, or conference, meeting, or convention organizers, as well as the specific location of the attendee within the event or meeting. Such location and/or digital representation information can be based at least in part on factors such as cellular service, WiFi, Bluetooth, GPS, WiMax, or the user digitally signing in. Utilization of attendance component 312 allows for the identification of attendees of specific events and/or for identification of conference presenters, speakers, fellow attendees, or conference organizers.

In addition, access point 302 can include transportation component 314 that can provide transportation tracking facilities so that conference or convention attendees can be appraised of transportation schedules (e.g., shuttle schedules, metro or subway timetables, taxi availability, . . . ). Transportation component 314 can provide transportation schedules to users based at least in part on a user's registration information or GPS location to facilitate just-in-time arrivals by users at the transportation stop (e.g., subway station, bus stop, airport terminus, etc.). Transportation schedules can be provided in a real-time fashion and in any digital format through utilization of tracking devices (e.g., GPS, . . . ) associated with the transportation means. Moreover, transportation component 314, in conjunction with mapping component 316, can provide maps of the airport terminal of the host city for display on mobile devices, as well as, facilitate the display of departing and/or arriving flights at the host city airport. Additionally, transportation component 314 can provide lists of the best taxi, limousine, or chartered car services and their associated telephone numbers in and around the convention center.

Moreover, access point 302 can further include mapping component 316 that can provide interactive maps of the convention center to mobile devices of registered conference attendees. The maps so supplied can provide the ability to identify and “click on” areas depicted on the map through touch-interfaces associated with the mobile device, and further, areas on the map can be identified with colors, icons, pictures, embedded audio and/or visual files, and other forms of digital media which can be used to aid navigation and/or for marketing or product placement purposes, wherein static or interactive advertisements can be displayed on the mobile devices of registered conference attendees or mobile devices of persons in proximity of access point 302. As will be appreciated, the maps distributed by mapping component 316 for display on mobile devices can also be employed by users to locate colleagues via GPS, WiFi, WiMax, cellular, Bluetooth, or other means. Additionally, mapping component 316 can facilitate dispersion of local weather reports and forecasts, and further can provide live weather radar feeds (e.g., an animated loop of the last 90 minutes) for the conference vicinity.

It should be noted that the maps provided to mobile device by mapping component 316 can be used to help mobile device users to navigate the conference or meeting arena more effectively and as such can provide turn-by-turn directions, overhead views, and/or first-person views. Additionally, it should also be noted, the maps can be series of digital images successively presented and/or overlaid, blueprints, photographs, or any other form of digital imaging. Further, not only can the maps be used to help mobile device users navigate the conference or meeting arena, but the maps can be provided for areas surrounding the conference or convention center. For example, hotels, restaurants, and other business establishments in the vicinity of the conference or convention center can be displayed. Moreover, the maps can be dynamically updated with activities (related or unrelated to the convention) in the areas surrounding the conference or convention locale, wherein the activities can be based on the user's interests. Such a facility can provide an income stream for convention organizers, wherein directed advertising, logos, signs, and other forms of digital media can be placed on areas of the map as advertising and can be played or accessed through the interactive map. Moreover, such directed advertising, logos, and other forms of digital media can be utilized as coupons for discounts or tickets to attend events associated with such advertising, as well as to provide the user the ability to text or instant message a vendor or advertiser to arrange for a meeting or other interaction, such as “concierge selling” or “valet pick-up”. In addition, incorporated into maps distributed to mobile devices can also be search functions that can allow users to locate items of interest and/or vendors of interest.

Additionally, through utilization of mapping component 316 vendors can identify the location of users through one or more tracking mechanisms, such as GPS, WiFi, Bluetooth, etc. Such a facility can be utilized by vendors to identify and/or locate potential clients (e.g., users of mobile devices) that are navigating within the general vicinity of the conference venue and can differentiate and/or target these users based on areas of interest or other pertinent information provided during registration for conferences and/or meetings.

Additionally, access point 302 can include store 318 that can include any suitable data necessary for access point 302 to facilitate it aims. For instance, store 318 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that store 318 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 318 of the subject systems and methods is intended to comprise, without being limited to, these and any other suitable types of memory. In addition, it is to be appreciated that store 318 can be a server, a database, a hard drive, and the like.

In addition to the components illustrated with regard to access point 302 other instrumentalities and functionalities can also be associated with access point 302. For instance, access point 302 can make beneficial use of data fusion components that can be utilized to take advantage of information fusion which may be inherent to a process (e.g., receiving and/or deciphering inputs) relating to analyzing inputs through several different sensing modalities. In particular, one or more available inputs can provide a unique window into a physical environment (e.g., an entity inputting instructions) through several different sensing or input modalities. Because complete details of the phenomena to be observed or analyzed may not be contained within a single sensing/input window, there can be information fragmentation which results from this fusion process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by access point 302, can include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

Additionally, access point 302 can, for example, employ a synthesis aspect to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Such a synthesis aspect through combining and filtering can provide a set of information that can be more informative, or accurate (e.g., with respect to an entity's communicative or informational goals) and information from just one or two modalities, for example. As discussed above data fusion aspects can also be employed to learn correlations between different data types, and the synthesis component aspect can employ such correlations in connection with combining, or filtering the input data.

Furthermore, access point 302 can determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. Thus ascertaining appropriate context can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during later hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, based at least in part on knowledge that the user was not camping, and that it was near dinnertime, the utterance would be interpreted as “steak”. On the other hand, if the context aspect knew (e.g., via GPS system input) that the user recently arrived at a camping ground within a national park; it might more heavily weight the utterance as “stake”. In view of the foregoing, it is readily apparent that utilization of context to consider and analyze extrinsic information can substantially facilitate determining meaning of sets of inputs.

In addition, access point 302 can include presentation aspects that can provide various types of user interface to facilitate interaction between a user and any component coupled to access point 302. Such presentation aspects can be distinct from, but utilizable by, access point 302. The presentation aspects can provide one or more graphical user interface, command line interface, and the like. For example, a graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed.

Users can also interact with regions to select and provide information via various devices such as a mouse, roller ball, keypad, keyboard, and/or voice activation, for example. Typically, mechanisms such as a push button or the enter key on the keyboard can be employed subsequent to entering the information in order to initiate, for example, a query. However, it is to be appreciated that the claimed subject matter is not so limited. For example, merely highlighting a checkbox can initiate information conveyance. In another example, a command line interface can be employed. For example, the command line interface can prompt (e.g., via text message on a display and/or an audio tone) the user for information via a text message. The user can then provide suitable information, such as alphanumeric input corresponding to an option provided in the interface prompt or an answer (e.g., verbal utterance) to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

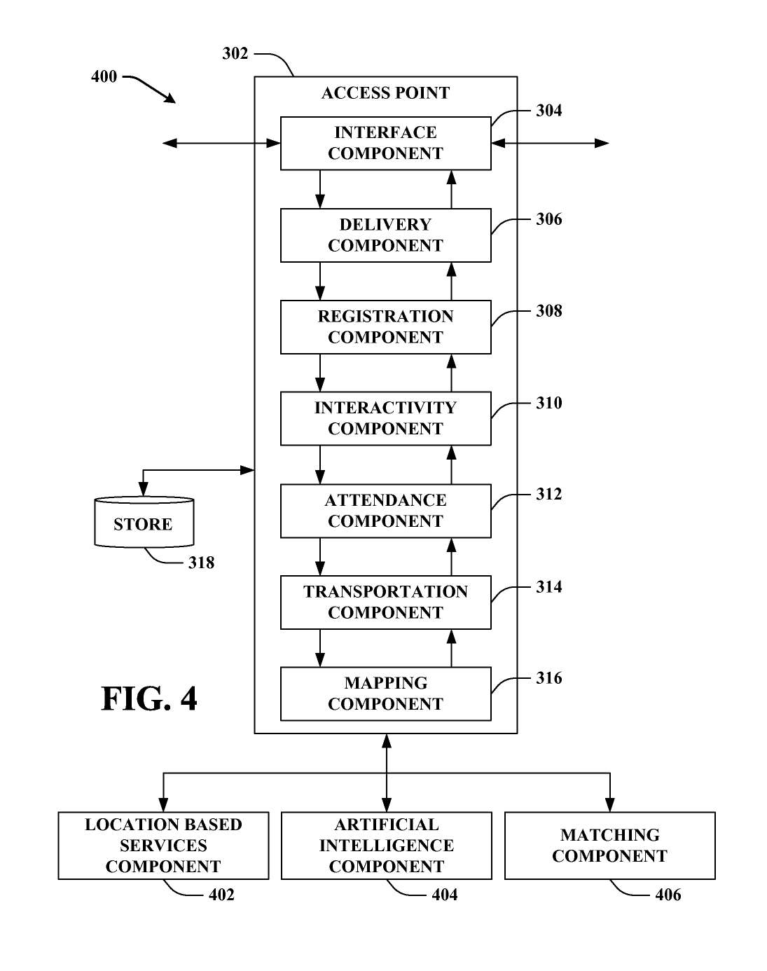

FIG. 4 provides further depiction 400 of an illustrative access point 302 in accordance with various aspects of the claimed subject matter as set forth herein. In addition to the aspects described in relation to FIG. 3 above, access point 302 can also include or interact with location based services component 402 that can acquire and/or receive location information for a set of mobile devices within the coverage range of access point 302. As will be appreciated, such location information can be received continuously or periodically, and moreover can be automatically or dynamically dispatched from the mobile devices (e.g., mobile devices 104A, 104E, or 104U) extant within the coverage range of access point 302 or periodically or continuously solicited by location based services component 402 from the mobile devices within the ambit of access point 302. Additionally, location information can be obtained from mobile devices as they respectively enter or exit the coverage area serviced by access point 302. Typically, location information can include any data indicative of the current location of a mobile device or information that can be utilized by location based services component 402 to deduce or approximate the location of the mobile device within the service area of access point 302. For example, location information can be provided by utilizing and measuring the signal strength emitted by a mobile device, or can be supplied through utilization of one or more triangulation algorithms. Furthermore, where multiple disparate and dispersed access points are being utilized, for example, within a defined or circumscribed area (e.g., conference center), location information can also be provided by each of the disparate and dispersed access points based at least in part on the signal strengths received at each of the access points. Additionally and/or alternatively, location information can be supplied through user input where the user elects to self-report, via facilities and/or functionalities provided by a mobile device, his or her current location. Nevertheless as will be appreciated by those moderately cognizant in this field of endeavor, a user can, and may, wish to prevent location based services component 402 from noting his or her whereabouts within the coverage area serviced by access point 302, and as such the user can selectively prevent location based services component 402 from acquiring location information from the mobile device or can put into abeyance (temporarily or permanently) the supply of location information from the mobile device to location based services component 402.

Provided that the user has permitted location information to be acquired by or supplied to location based services component 402, location based services component 402, in conjunction with one or more triangulation techniques, can provide tracking facilities and/or functionalities wherein, based at least in part on location information successively ascertained or deduced by location based services component 402 regarding the whereabouts of a mobile device within the coverage or service area of access point 302, location based services component 402 can track the perambulation of the user through such location information.

In addition, location based services component 402 can also provide route planning within the facility and/or in the general vicinity surrounding the conference facility. For instance, location based services component 402 can utilize location information acquired from and/or supplied by a mobile device and data deduced or ascertained by location based services component 402, and in concert with the facilities and/or functionalities provided mapping component 316 can provide route planning (e.g., dynamically updatable real-time directions) to various points of interest within the conference center and well as to venues in the area surrounding the conference facility (e.g., restaurants, theaters, hotels, shopping malls, transportation stops, . . . ). The route planning facilities provided by location based services component 402 can include turn-by-turn directions or directions utilizing one or more maps generated by mapping component 316.

Additionally, access point 302 can also include or interact with artificial intelligence component 404 that can employ a probabilistic based or statistical based approach, for example, in connection with making determinations or inferences. Inferences can be based in part upon explicit training of classifiers (not shown) and/or implicit training based at least in part upon system feedback and/or users previous actions, commands, instructions, and the like during use of the system. Artificial intelligence component 404 can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Further, artificial intelligence component 404 can factor historical data, extrinsic data, context, data content, state of the user, and can compute cost of making an incorrect determination or inference versus benefit of making a correct determination or inference. Accordingly, a utility-based analysis can be employed by providing such information to other components or taking automated action. Ranking and confidence measures can also be calculated and employed in connection with such analysis.

Access point 302 can also interact with or include matching component 406 that, individually and/or in conjunction with location based services component 402 and artificial intelligence component 404, can obtain profiles (e.g., persisted on store 318 or retrieved from one or more remote data stores) associated with a user as well as profiles associated with one or more disparate users (e.g., conference, meeting, or convention attendees) and thereafter can compare the retrieved and/or acquired user profiles with the one or more received and/or obtained disparate user profiles to ascertain commonalities of interests that these parties may have. Commonalities of interest can include or be based at least in part on academic achievements, fields of specialty, training, personal likes or dislikes, collaborative distances ascertained between the user and the one or more disparate users (e.g., Erdös number, Erdös-Bacon number, etc.) or associations with other colleagues, demographic attributes, expertise in a specialized field of endeavor, place of business, and the like, associated with each of the one or more disparate users and/or the user.

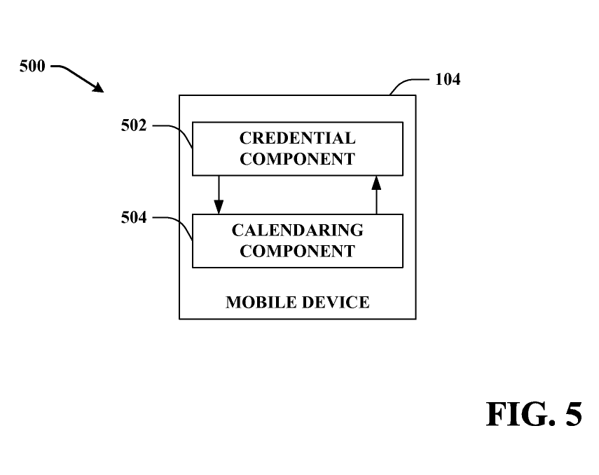

FIG. 5 provides depiction 500 of an illustrative mobile device 104 that can receive pertinent and/or selected content from one or more access points dispersed throughout a conference center. As illustrated mobile device 104 can include credential component 502 that can be a repository of various credential information associated with the user of mobile device 104. Examples of such credential information can include encryption/decryption keys necessary to lock and/or unlock financial and personal information persisted on mobile device 104 so that the user can disburse payment for the conference or meeting attendance.

Additionally, mobile device 104 can include calendaring component 504 that can be utilized by the user to schedule meetings and can be utilized by aspects of the claimed subject matter (e.g., access point 302) to provision mobile device 104 with appropriate and customized agendas for the various conferences and meetings for which the user elicits an interest.

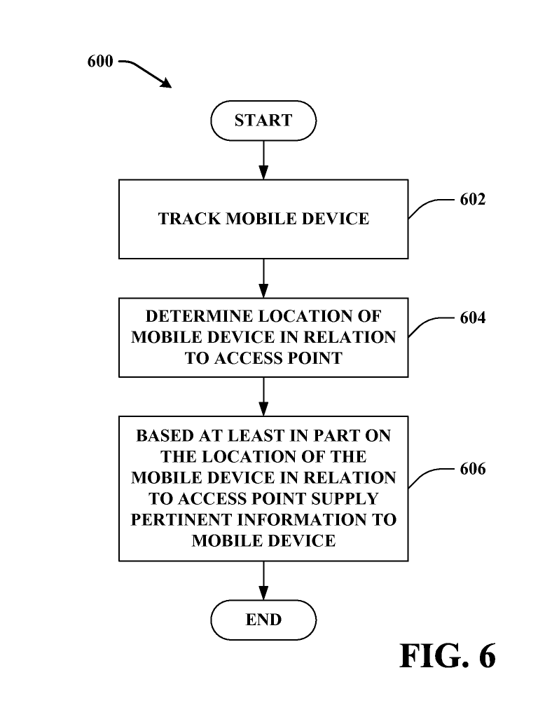

In view of the illustrative systems shown and described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 6 depicts a method 600 that streams pertinent and/or selected content to a mobile device based at least in part on the location of the mobile device in relation to an access point. Method 600 can commence at 602 where an access point can track the movement of a mobile device that is within the vicinity of the access point. At 604 a determination can be made as to the location of the mobile device in relation to the access point, and at 606, based at least in part on the location of the mobile device in relation to the access point, the access point can supply pertinent agenda and conference information to the mobile device.

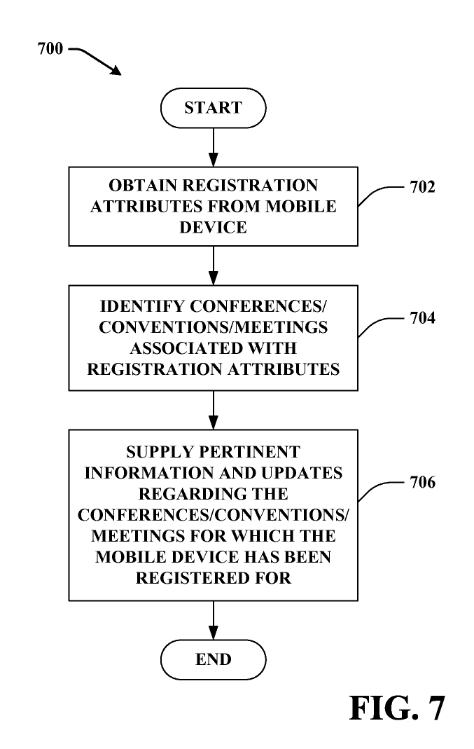

FIG. 7 depicts a further method 700 that streams pertinent and/or selected content to a mobile device based at least in part on the location of the mobile device in relation to an access point. Method 700 can commence at 702 where registration attributes, such as user identification, mobile device attributes, and/or payment information, can be obtained from a mobile device. At 704, based at least in part on the obtained registration attributes, conferences, conventions, and/or meetings associated with the registration information can be identified. At 706, based on the identified conferences, conventions, and/or meetings, pertinent information and updates regarding the identified conferences, conventions, and/or meetings for which the mobile device (and its user) has been registered for can be supplied to the mobile device.

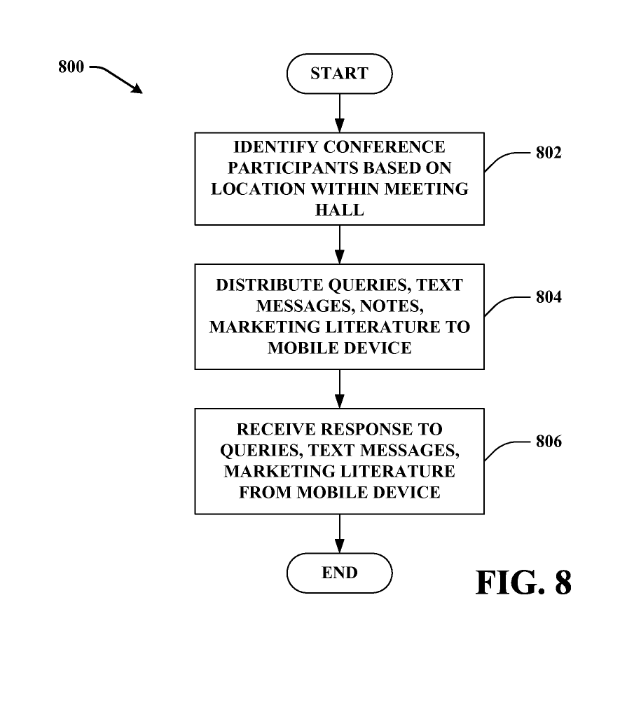

FIG. 8 depicts yet a further methodology 800 that streams pertinent and/or selected content to a mobile device based at least in part on the location of the mobile device in relation to an access point. Methodology 800 can commence at 802 where conference or meeting participants can be identified based on their location within the conference center or meeting hall. At 804 various and sundry queries, text messages, notes, or marketing literature, and the like can be distributed to the mobile device. At 806 responses to previously disseminated queries, text messages, or marketing literature can be received back from the various responding mobile devices.

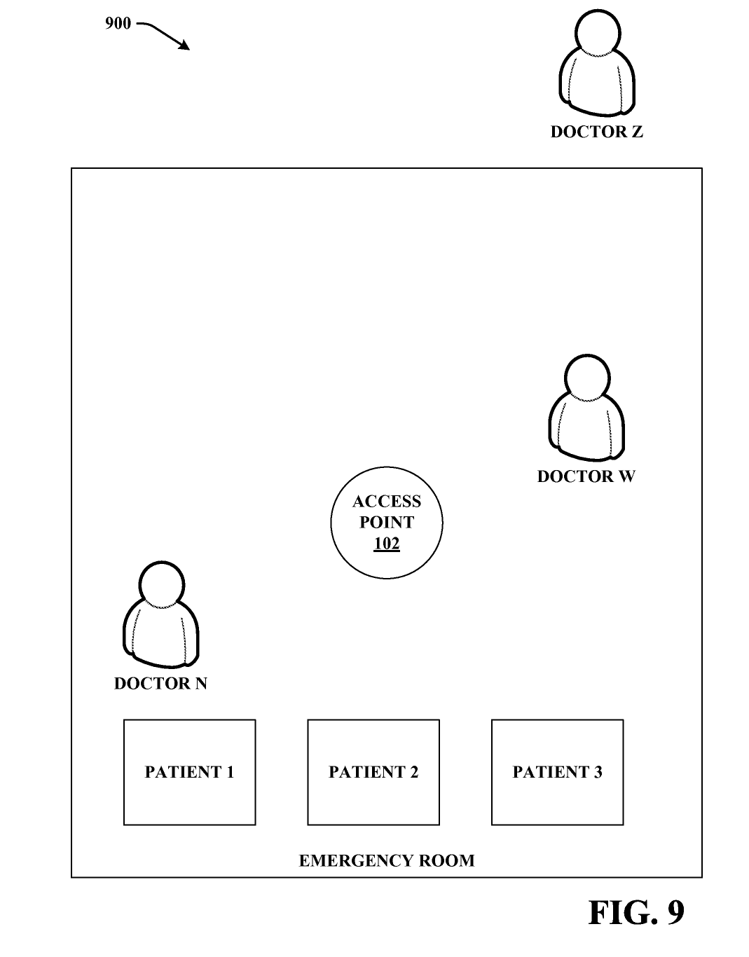

FIG. 9 illustrates a further utilization of the claimed subject matter 900 wherein access point 102 has been situated within a medical facility (e.g., hospital), and more particularly, situated in an Emergency Room located within the medical facility. As will be appreciated, access point 102 can be one of many access points dispersed throughout the medical facility, but in this instance access point 102 can specifically be directed towards the streaming of pertinent and/or selected content to mobile devices associated with the various physicians (e.g. Doctor N, Doctor W, and Doctor Z) and/or personnel working in the Emergency Room.

As depicted Doctor Z can be associated with a first mobile device and can be situated outside the Emergency Room coverage area dynamically circumscribed by access point 102. For example, Doctor Z who typically works in the Emergency Room can be returning to the Emergency Room after having visited the Radiology department regarding Patient 1. Doctor Z for the purposes of this illustration can be a fully licensed physician and can be supervising the medical residencies of Doctor N—a first year Emergency Room resident and Doctor W—a second year Emergency Room resident. Accordingly, access point 102, in recognition that Doctor Z and his or her mobile device is currently outside the ambit (or at the near periphery) of its coverage area, can disseminate or stream pertinent but high level outline information regarding the status of patients in the Emergency Room, and in particular, can stream high level outline information for patients directly or indirectly under his or her charge to Doctor Z's mobile device. As will be appreciated by those of moderate skill in this field of endeavor, since Doctor Z can be the supervisory physician within the Emergency Room, access point 102 can supply high level overviews and/or updates to patient records (e.g., records and/or updates for Patient 1, Patient 2, and Patient 3). Nevertheless, as Doctor Z moves closer to or within the coverage area dynamically circumscribed by access point 102 as bounding the Emergency Room control or service space, richer and more detailed information regarding each of the patients in the Emergency Room can be dispatched to Doctor Z's mobile device.

Further as illustrated in FIG.9, Doctor N can be charged with treating Patient 1, and because of Doctor W's greater experience, Doctor W can be charged with treating Patient 2 and Patient 3. In accordance with this aspect of the claimed subject matter, the information streamed in varying degrees of detail to Doctor N would relate only to Patient 1 and would not be cross contaminated with information regarding Patients 2 and 3; Doctor W, unless authorized, will not be provided details regarding Patient 1. Similarly, with respect to Doctor W and Patient 2 and Patient 3, access point 102 will selectively stream information regarding Patient 2 and Patient 3 to a mobile device carried by Doctor W; details (in précis or overview form or in varying levels of detail or specificity) related to Patient 2 and Patient 3, unless there has been authorization, will not typically be streamed to Doctor N. Nonetheless, it should be noted without limitation or loss of generality, that while access point 102 will segregate or fractionate the supply of information so that Doctor N only receives information related to Patient 1 and Doctor W will receive information related to Patient 2 and Patient 3, Doctor Z being the supervisory physician can be streamed information related to Patient 1, Patient 2, and Patient 3 in varying degrees of specificity wherein the degrees of particularity with which Doctor Z receives Patient 1, Patient 2, and Patient 3 information can be a function of the ascertained distance (e.g., ascertained by access point 102) that Doctor Z is from the Emergency Room and/or the ascertained distance that Doctor Z is away from a particular patient. It should further be noted in connection with Doctor W, that since Doctor W is charged with the treatment of Patient 2 and Patient 3, access point 102 can selectively provide more detailed information regarding Patient 2's medical history where Doctor W is in relatively close proximity to Patient 2 and conversely can provide less detailed information regarding Patient 3's medical history since Doctor W is relatively distant from Patient 3. However, with regard to the specificity of information provided to Doctor W in connection with Patient 2 and Patient 3, vital information (e.g., life critical) regarding Patient 2 and Patient 3 can, at a minimum, be dispatched to Doctor W irrespective of where Doctor W is in the Emergency Room or the health facility (e.g., hospital). A similar functionality or facility can be provided by access point 102 in connection with Doctor N and Doctor Z and the patients for which they have responsibility.

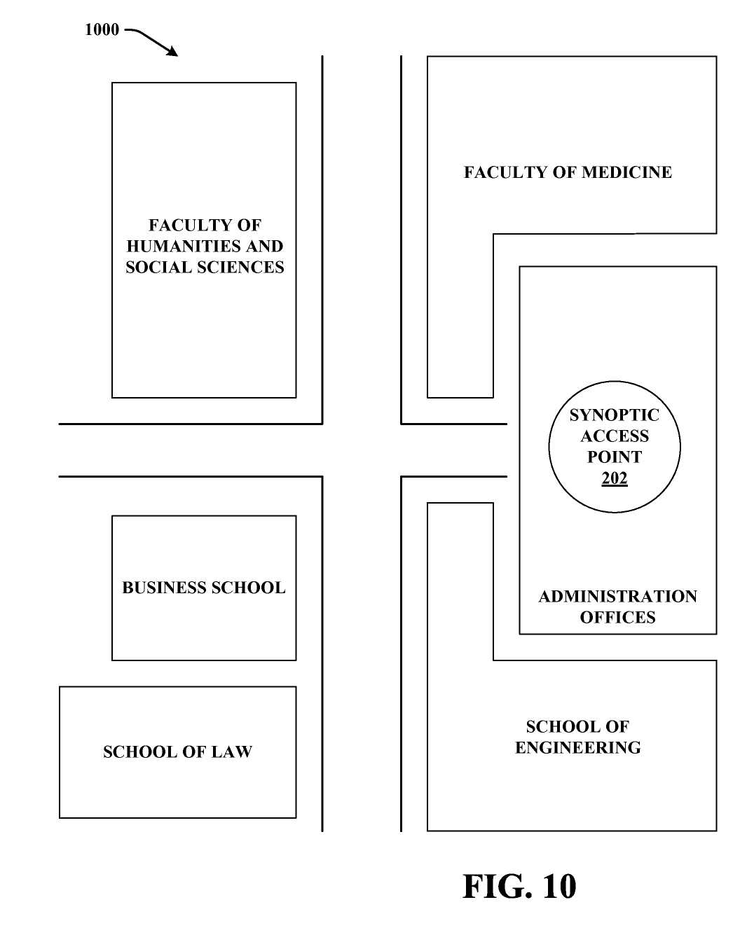

Turning now to FIG. 10 which illustrates yet a further utilization of the claimed subject matter 1000 wherein synoptic access point 202 has been positioned within the administrative offices of a university campus. As illustrated, the university campus can include a number of departments, schools, and academic faculties, such as the faculties of medicine, humanities and social sciences, and the schools of business, law, and engineering. It should be noted that each of the aforementioned departments, schools, and/or academic faculties can each have located therein a plurality of access points that can be subservient to synoptic access point 202 (e.g., similar in functionality and facility to factotum access points 204A and 204M illustrated in connection with FIG. 2) and as such synoptic access point 202 can act as a unified point for the dispersion of generalized information gathered from the plurality of subservient access points located throughout the university campus to one or more mobile devices that come within the ambit of synoptic access point 202. For example, if a mobile device comes within the purview of synoptic access point 202, synoptic access point 202 can stream to such a mobile device a generalized high level overview of the university, and its many departments, schools, and academic faculties. Additionally, synoptic access point 202 can also disseminate other pertinent information about the university, such as lists of alumni, history of the university, academic and sporting achievements that have been attained by the university's faculty and its student body, etc.

Further, synoptic access point 202 can track a mobile device as it traverses through the campus. Accordingly, as the mobile device passes by various points of interest synoptic access point 202 can disperse more pertinent information related to these points of interest. For instance, as a mobile device moves within the purview of the faculty of medicine, one or more factotum access points (not shown) located within the faculty of medicine can indicate to synoptic access point 202 that the mobile device is within service or control range of the faculty of medicine and based at least in part on such indication synoptic access point 202 can provide more detailed and specific information regarding the faculty of medicine. Similarly, where a mobile device traverses between the school of engineering and the business school and school of law more detailed or less detailed information can successively be provided to the mobile device by synoptic access point 202. For example, as the mobile device moves from the school of engineering to within the vicinity of the business school, more specific information related to the business school can be directed to the mobile device and conversely as more detailed information related to the business school is being directed to the mobile device, less specific information related to the school of engineering can be distributed to the mobile device. Correspondingly, where a mobile device is situated at the conflux of coverage areas provided by two or more factotum access points, for instance where service areas provided by factotum access points located or associated with the school of engineering, school of law, and the business school intersect, an equal amount of information regarding each of the school of engineering, school of law, and the business school can be directed to the mobile device. However, should the mobile device move closer to one of the school of engineering, school of law, or the business school, successively more detail regarding one of the school of engineering, school of law, or the business school can be presented at the expense or gradual diminishment of detail as the mobile device moves away from the control space or service area circumscribed with regard to the remaining two, for instance.

It should be appreciated without limitation or loss of generality that while the claimed subject matter has been explicated in terms of factotum access points that have been geographically and/or topographically dispersed and/or are distinct and/or separate from the synoptic access points set forth herein, it nevertheless is to be understood that synoptic access points and factotum access points can be co-located with one another and/or that a single synoptic access points can provide the facilities and/or functionalities of a plurality of factotum access points.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

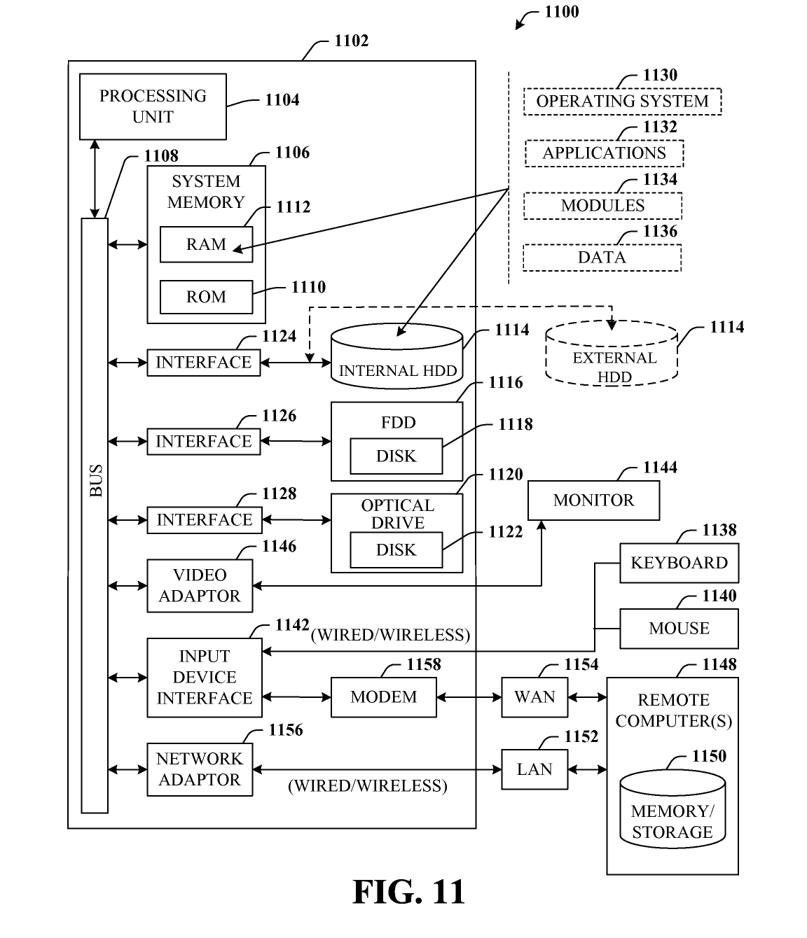

Referring now to FIG. 11, there is illustrated a block diagram of a computer operable to execute the disclosed system. In order to provide additional context for various aspects thereof, FIG. 11 and the following discussion are intended to provide a brief, general description of a suitable computing environment 1100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the illustrative environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the claimed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1094 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are illustrative and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

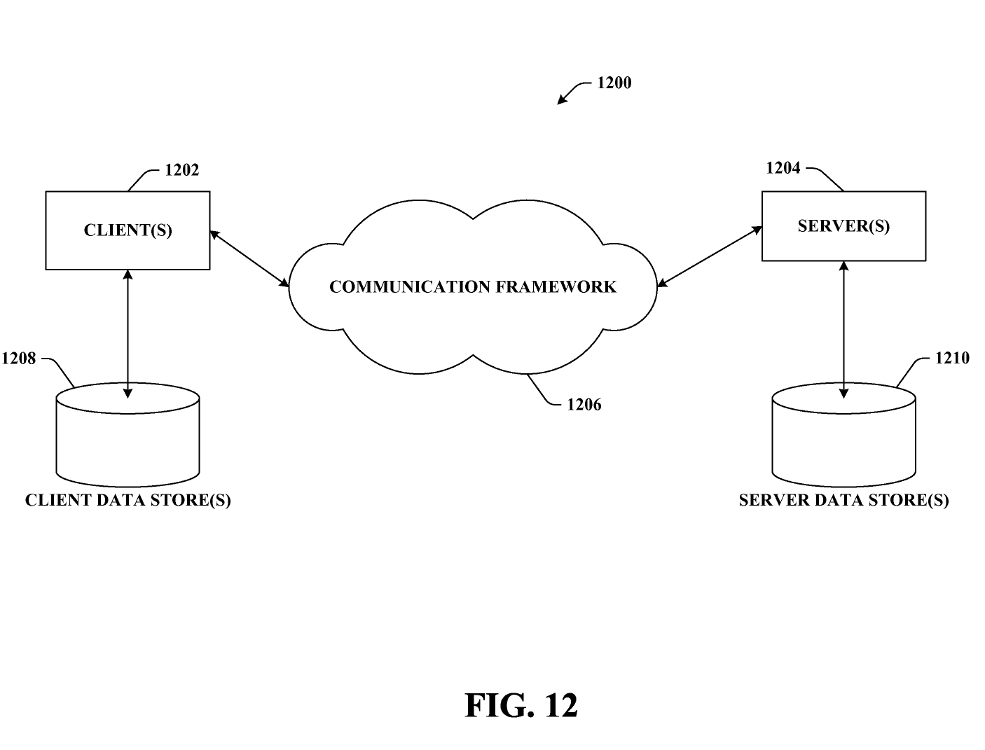

Referring now to FIG. 12, there is illustrated a schematic block diagram of an illustrative computing environment 1200 for processing the disclosed architecture in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that streams pertinent content to a mobile device, comprising:
detecting the mobile device within a broadcast coverage area demarcated by an access point;
determining the mobile device location with respect to the access point; and
based at least in part on the mobile device location in relation to the access point, supplying content to the mobile device.

2. The method of claim 1, the content includes a conference agenda customized for a user of the mobile device.

3. The method of claim 2, the customized conference agenda includes interactive portions with which the user can interact.

4. The method of claim 1, further comprising utilizing the mobile device location to register a user associated with the mobile device to an event serviced by the access point.

5. The method of claim 1, further comprising utilizing one or more user preference associated with a user of the mobile device to schedule registration for at least one future event.

6. The method of claim 1, further comprising employing the mobile device location to provide information to a user regarding an on-going event.

7. The method of claim 1, the access point positioned centrally within an event arena.

8. The method of claim 1, based at least in part on a distance from the access point to the mobile device, the access point supplies content of greater or lesser detail to the mobile device.

9. An apparatus, comprising:
a memory that retains instructions related to identifying a mobile device within a broadcast coverage range circumscribed by an access point, ascertaining the mobile device position with respect to the access point, and supplying content to the mobile device based at least in part on the mobile device position in relation to the access point; and
a processor, coupled to the memory, configured to execute the instructions retained in the memory

10. The apparatus of claim 9, wherein the memory retains instructions related to employing the mobile device position in relation to the access point to provide event information of various degrees of granularity.

11. The apparatus of claim 10, wherein the event information includes information related to users of other mobile devices within the broadcast coverage range circumscribed by the access point.

12. The apparatus of claim 10, wherein the event information includes updates to event information previously disseminated to the mobile device.

13. The apparatus of claim 10, wherein when the mobile device position is at the periphery of the broadcast coverage range circumscribed by the access point, the event information provided to the mobile device is least granular.

14. The apparatus of claim 10, wherein when the mobile device position is closest to the access point the event information provided to the mobile device is most granular.

15. The apparatus of claim 9, wherein the memory retains instructions related to obtaining event information from other access points associated with individual events and summarizing the event information from the other access points to provide a least granular overview of the event information.

16. A wireless communications apparatus, comprising:
a processor configured to:
detect a mobile device within a broadcast coverage area circumscribed by an access point;
determine the mobile device location within the broadcast coverage area; and
supply digital content to the mobile device based on the mobile device location.

17. The wireless communications apparatus of claim 16, wherein the processor is further configured to employ the mobile device location to register a user associated with the mobile device to an event serviced by the access point.

18. The wireless communications apparatus of claim 16, wherein the processor is further configured to utilize a user preference associated with a user of the mobile device to reserve hotel accommodation for an event serviced by the access point.

19. The wireless communications apparatus of claim 16, wherein the processor is further configured to utilize a user preference associated with a user of the mobile device to recommend one or more future event serviced by the access point.

20. The wireless communications apparatus of claim 16, wherein the processor is further configured to obtain event information from other access points associated with individual events and summarize the event information from the other access points to provide a least granular overview of the event information.
